(19) United States
(12) Patent Application Publication
(10) Pub. No.: US 2024/0122396 A1
(43) Pub. Date: Apr. 18, 2024

(54) BEVERAGE PREPARATION DEVICE

(71) Applicant: Franke Kaffeemaschinen AG, Aarburg (CH)

(72) Inventor: Simon MÜLLER, Muhen (CH)

(73) Assignee: Franke Kaffeemaschinen AG, Aarburg (CH)

(21) Appl. No.: 18/278,862

(22) PCT Filed: Jan. 31, 2022
(86) PCT No.: PCT/EP2022/052159

§ 371 Date: Aug. 25, 2023

(30) Foreign Application Priority Data
Mar. 31, 2021 (DE) 10 2021 108 202.1

(51) Int. Cl. A47J 31/36; A47J 31/42; A47J 31/46; A47J 31/52

(52) U.S. Cl. CPC A47J 31/3671; A47J 31/42; A47J 31/461; A47J 31/467; A47J 31/469; A47J 31/5255

(57) ABSTRACT

A beverage preparation apparatus for automatically dispensing hot beverages, in particular coffee beverages, having a hot water preparation unit which supplies hot water to a brewing apparatus, a water pump for conveying pressurized water in the direction of the brewing apparatus, an outlet device connected to the brewing apparatus via a hot beverage line and a controller which controls automatic preparation and dispensing of the selected beverage after beverage selection. The controller varies the brewing pressure at which the hot water is supplied to the brewing apparatus or the throughflow rate at which the hot water is conveyed, over the preparation operation of the selected beverage in accordance with a predetermined or predeterminable profile. The beverage preparation apparatus has a mechanical operating element having an electrical consumer connected to the controller and via which the profile can be predetermined by a user during a beverage preparation operation.

### CROSS-REFERENCE TO RELATED APPLICATIONS

This application is a 371 National Phase of PCT/EP2022/052159, filed Jan. 31, 2022, which claims priority from German Patent Application No. 10 2021 108 202.1, filed Mar. 31, 2021, both of which are incorporated herein by reference as if fully set forth.

### TECHNICAL FIELD

The present invention relates to a beverage preparation apparatus for automatically dispensing hot beverages, in particular coffee beverages, having a hot water preparation unit, a brewing apparatus to which hot water can be supplied from the hot water preparation unit, a water pump for conveying pressurized water in the direction of the brewing apparatus, an outlet device which is connected to the brewing apparatus via a hot beverage line and a controller which controls automatic preparation and dispensing of the selected beverage after a beverage selection has been carried out.

### BACKGROUND

In the prior art, fully automatic coffee machines which are used to prepare and dispense coffee-based beverages in a metered manner are known. In this instance, the beverage selection is carried out via a user interface. After selecting a beverage variant, a coffee beverage is prepared in accordance with the user specifications by means of an integrated brewing apparatus and dispensed at a beverage outlet. Often, in addition to the mentioned hot beverage outlet, outlets for additional beverage components, such as, for example, milk, milk foam or flavor additives, are provided. The outlets can be grouped in this instance to form an outlet head which is arranged securely on the fully automatic coffee machine.

In addition, there are known in the prior art so-called filter holder machines, in which instead of an outlet head a filter holder with an outlet which is fitted thereto is fixed in a sealing manner. In order to prepare coffee, the filter holder is removed and filled with powdered coffee, fixed to the filter holder machine again and acted on thereby under pressure with hot water until a predetermined quantity of hot water has run through the coffee filter which is contained in the filter holder and the coffee grounds which are contained in the coffee filter. Other beverage additives, such as, for example, milk or milk foam, are added to the coffee beverage manually by the barista.

Finally, there are also known hybrid systems in which a filter holder is also used, but it is automatically filled with ground coffee powder via an integrated coffee mill. Such a hybrid coffee machine is described, for example, in WO 2010 08 58 50 A1.

The coffee from filter holder machines is still valued by many coffee lovers as being of a greater quality in terms of flavor, particularly since the barista can exert an influence on the preparation as a result of his/her technical ability and therefore ultimately also on the flavor of the coffee beverage.

However, fully automatic coffee machines allow automatic preparation and dispensing of coffee beverages with uniform flavor quality at the press of a button.

### SUMMARY

An object of the present invention is to provide a beverage preparation apparatus which allows automatic preparation and dispensing of hot beverages but which nevertheless permits influence to be exerted and an improvement in quality of a beverage preparation by an experienced user.

The object is achieved by a beverage preparation apparatus with one or more of the features disclosed herein. Advantageous embodiments can be derived from the following description and claims.

In a beverage preparation apparatus of the type mentioned in the introduction, there is provision according to the invention for the controller to be constructed to vary the brewing pressure at which the hot water is supplied to the brewing apparatus or the throughflow rate at which the hot water is conveyed, over the preparation operation of the selected beverage in accordance with a predetermined or predeterminable profile, and wherein the beverage preparation apparatus has a mechanical operating element having an electrical consumer which is connected to the controller in order to predetermine the profile.

A basic notion of the present application involves not simply keeping the brewing pressure or the throughflow rate constant by means of the controller over the preparation operation, but instead varying it in accordance with a profile over the course of time, wherein the profile can be predetermined by a user, and can be stored either for a specific preparation operation or for future preparation operations of the same beverage type. To this end, the beverage preparation apparatus has a mechanical operating element having an electrical consumer which is connected to the controller. Using the operating element, the user can consequently change the desired brewing parameter, that is to say, the brewing pressure or the throughflow rate, over time, and can consequently predetermine a very individual profile for the preparation of a specific beverage or beverage type.

The water pump is preferably located upstream of the hot water preparation unit and therefore in the cold water supply flow of the hot water preparation unit. Naturally, it would also be possible with a pump, which is suitable for hot water, to arrange it between the hot water preparation unit and the brewing apparatus. In a manner known per se, either a boiler or a flow heater can be used as a hot water preparation unit.

In a preferred embodiment, the variation of the brewing pressure is carried out via control of the speed or the power of the water pump. Consequently, the pump speed can be increased or decreased via the operating element during a preparation operation so that water at increased or decreased pressure is conveyed to the brewing apparatus.

Alternatively or additionally, a controllable counter-pressure valve can be arranged in the throughflow direction downstream of the brewing apparatus. In this instance, it is possible to bring about the variation of the brewing pressure or the throughflow rate via an adjustment of a valve opening of the counter-pressure valve. Consequently, the valve opening of the counter-pressure valve can be increased or decreased via the operating element during a preparation operation so that a higher or lower counter-pressure is produced at the counter-pressure element.

In a preferred embodiment, the beverage preparation apparatus has a measuring device, which is arranged upstream or downstream of the brewing apparatus, for determining a volume flow of the brewing water or a quantity of the brewing water which has already been guided through or which has yet to be guided through and an adjustable counter-pressure valve which is arranged in the throughflow direction downstream of the brewing apparatus. In this case, the controller is constructed to vary the brewing pressure, at which the hot water is supplied to the brewing apparatus, in accordance with a pressure profile which is predetermined via the operating element and to control the throughflow rate of the brewing water via the counter-pressure valve in accordance with measurement values of the measurement apparatus during the brewing operation in such a manner that during the preparation operation, independently of the pressure profile which is predetermined via the operating element, a total quantity of brewing water as predetermined for the selected beverage is guided through within a predetermined total throughflow time.

In other words, the brewing pressure is varied via the operating element over time while a throughflow control is sought using the counter-pressure valve so as to always adapt the throughflow rate so that a substantially constant total passage time for the predetermined total water quantity is reached.

The change of the brewing pressure is advantageously carried out by controlling the pump. Consequently, both a profile for the brewing pressure and a total throughflow time can be predetermined. The brewing time and brewing pressure have been found to be the most important parameters for influencing the flavor of the coffee beverage so that the barista acquires extensive possibilities for exerting an influence on the beverage quality with his/her technical ability and his/her experience of preparing coffee.

Advantageously, the counter-pressure valve is in the form of a motor-operated needle valve and the control unit opens and closes the needle valve by controlling a drive motor. As a result of a needle valve, it is possible to bring about a particularly fine adjustment of the throughflow rate so that the throughflow rate can be adjusted very precisely via a feedback control system.

A throughflow sensor which is arranged in the flow direction upstream of the water pump or between the water pump and the brewing apparatus and which is consequently advantageously located in the cold water flow is preferably used as the measurement device. On the one hand, consequently, no cooling of the hot water is carried out by the throughflow sensor which had to be heated up only at the beginning of a product purchase. Furthermore, the use in cold water reduces the wear at the throughflow sensor with respect to use in the hot water flow.

Advantageously, the control unit is constructed to establish continuously, or at least several times, from measured volume flow values the quantity of the brewing water which has already been guided through or which still has to be guided through and, according to how much brewing water still has to be guided through the brewing apparatus in order to achieve the predetermined total quantity in the remaining time until reaching the predetermined total throughflow time, to further open or to further close the counter-pressure valve in order to increase or decrease the volume flow.

In a preferred embodiment, the mechanical operating element is in the form of an operating lever which can be redirected from a neutral position in a first direction in order to increase the pressure or the throughflow rate and in a second direction in order to reduce the pressure or the throughflow rate. Such an operating lever allows particularly intuitive operation. For example, the operating lever can be pivoted upward or forward in order to increase the brewing pressure or the throughflow rate and downward or backward in order to decrease it. If the operating lever is arranged on or adjacent to the outlet device, a particularly ergonomic and intuitive capacity for operation is produced.

In this instance, it is particularly advantageous if the beverage preparation apparatus is constructed to output an optical, acoustic or haptic confirmation signal when the operating element is actuated. For example, the pressure or the throughflow rate can be displayed in the form of a bar or triangle which is displayed on a graphic display and which is depicted to be larger or smaller depending on the position of the operating lever. A haptic confirmation signal can, for example, be output directly to the operating lever, for example, in the form of an engagement or an actuation resistance, which increases continuously with redirection of the operating lever, or a restoring force which increases with redirection of the operating lever or which can be felt by the user.

The position of the operating lever can be read via the control unit according to the invention. This can be carried out either as a continuous signal, for example, via a potentiometer, or as a digital signal, for example, via a plurality of mechanical push-buttons.

In a preferred embodiment, the controller has a training mode, in which a profile is input by actuating the operating element and the input profile is stored for subsequent automatic product purchases. Consequently, the barista can input an individual profile, which is called up and carried out repeatedly during subsequent product purchases.

In another embodiment, the beverage preparation apparatus has at least one outlet head which can be fixed to the outlet device for dispensing one or more beverage components which is/are guided to the outlet device via separate food product lines and the outlet device has a mechanical interface for connecting the outlet head in a sealing manner. In this instance, it is particularly advantageous if a plurality of outlet heads which can be connected alternately to the outlet device are provided for different beverages or beverage groups. For example, a first outlet head can be provided for an individual espresso and a second outlet head with a double outlet can be provided for dispensing a double espresso in two espresso cups. Similarly, separate outlet heads may be provided for milk-containing and/or flavored beverages.

The outlet heads may preferably be in the form of a filter holder but the upper side of which is formed by a sealing face which is provided with connection openings but is otherwise closed. The operation of the machine is consequently equivalent to operating a conventional filter holder machine with the difference that the beverage preparation is carried out in the manner of a fully automatic beverage machine, but with the possibility of manual variation of the pressure profile or the profile of the throughflow rate.

More preferably, the beverage preparation apparatus is in the form of a real fully automatic coffee machine and has a grinding mechanism for grinding coffee beans, which cooperates with the brewing apparatus in order to automatically fill it with a metered quantity of freshly ground powdered coffee. Simply by selecting a beverage which is intended to be dispensed, for example, via a graphic user interface, a fully automatic preparation and dispensing of the beverage are consequently carried out, including the coffee beans being ground and the brewing apparatus being filled.

However, the present invention is not limited to fully automatic coffee machines but can instead be used in metered coffee machines which are operated with coffee capsules or pods.

### BRIEF DESCRIPTION OF THE DRAWINGS

Other embodiments and advantages of the present invention will be appreciated from the following description of exemplary embodiments and the Figures, in which:

FIG. 1 shows a view of a beverage preparation apparatus in the form of a double device,

FIG. 2 shows a water flow diagram of a beverage preparation apparatus and

FIG. 3A shows a removable outlet head which can be used with a beverage preparation apparatus according to the invention with a double outlet, and

FIG. 3B shows two additional outlet heads which can be used alternately with a beverage preparation apparatus according to the invention.

### DETAILED DESCRIPTION

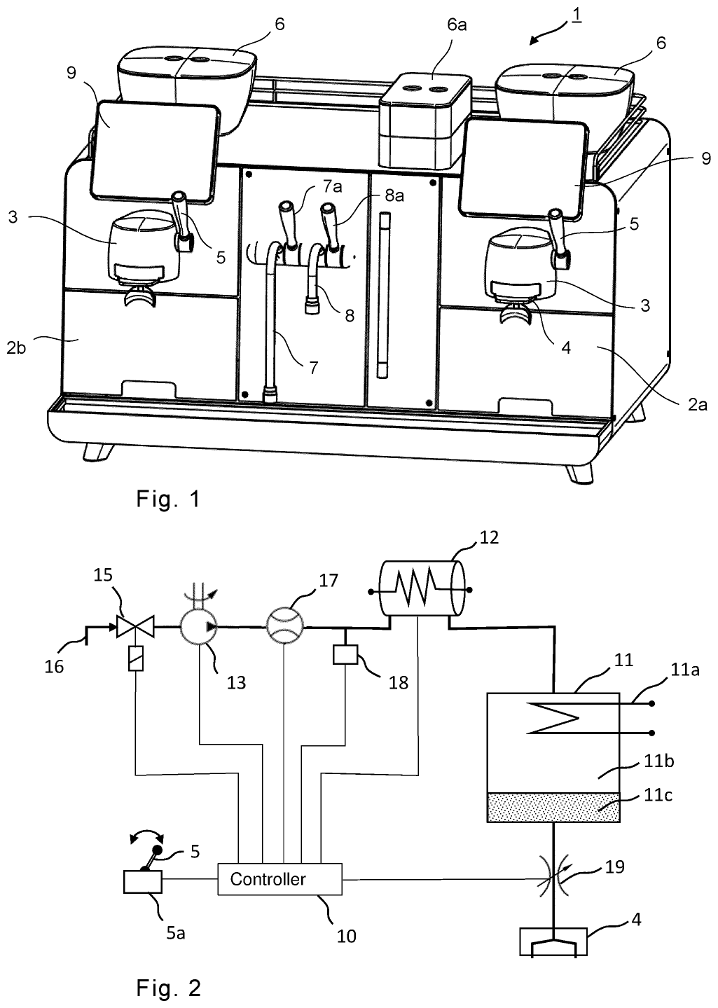

The coffee machine 1 shown in FIG. 1 is in the form of a double device having two separate coffee preparation apparatuses 2a, 2b. Each of the coffee preparation apparatuses 2a, 2b has an outlet device 3 having an outlet head 4 which is received therein and which has an outflow, via which prepared coffee beverages are dispensed into a drinking vessel which is placed below.

An operating lever 5, which can be pivoted out of the neutral position thereof upward and downward, is fitted to the outlet device 3. The operating lever 5 is used in the manner which will be explained in greater detail below to predetermine a profile for the brewing pressure or the throughflow rate at which a beverage which is currently or in the future intended to be dispensed is prepared.

Two bean containers 6 for fresh coffee beans are located at the upper side of the device. They lead to an electric coffee grinder which is arranged under the bean containers 6 and which grinds powdered coffee in a metered manner for preparing individual coffee beverages. Furthermore, the coffee machine 1 has a powder container 6a for instant powder, for example, chocolate powder, with which an instant beverage can be prepared as an additional beverage component.

A touch-sensitive display 9 is arranged above the outlet device 3 as a graphic user interface. Different available beverage variants can be displayed for a user thereon and selected by the user. After a selection has been carried out, an automated preparation and dispensing of the selected beverage is carried out, wherein via the operating lever 5 a preparation parameter, such as the brewing pressure or the throughflow rate during the preparation, can be varied.

A steam lance 7, via which steam for foaming milk can be discharged by actuating an operating lever 7a, is located centrally on the device. Beside it there is located an outlet tap 8 for hot water. By actuating an additional operating lever 8a, hot water can be discharged from the outlet tap 8, for example, for preparing tea or for flushing out and preheating cups.

FIG. 2 shows, in a so-called water flow diagram, the structure of a brewing apparatus for preparing coffee beverages which can be used, for example, in the beverage preparation apparatuses 2a, 2b. The brewing apparatus comprises a brewing group 10, a hot water preparation unit 12 in the form of a flow heater which is in the form of a heating cartridge, a supply-side water pump 13 and an outlet head 4 for dispensing freshly brewed coffee beverages. There is located upstream of the water pump 13 in the flow direction a main water valve 15, via which the brewing apparatus is connected to a drinking water supply line 16. At the pressure side, the pump 13 is connected via a throughflow sensor 17 (flow meter) to the supply of the heating cartridge 12. Hot water from the heating cartridge 12 is supplied to the brewing group 10.

An adjustable counter-pressure valve 19, which is controlled by a control unit 10 in accordance with the measurement values of the throughflow sensor 17, is located between the brewing group 10 and the outlet head 4. In this instance, the control unit 10 can be produced by a microprocessor, with which other control and adjustment operations in the beverage preparation apparatus can also be implemented. Furthermore, the operating lever 5 or an electrical consumer which is associated with the operating lever 5 and which reads the position of the operating lever 5 is connected to the control unit 10.

The control unit 10 is further connected to the water pump 13 and controls inter alia the speed and therefore the conveying capacity of the water pump 13. Furthermore, a pressure sensor 18, the measurement values of which are read by the control unit 10, is located in the cold water supply of the heating cartridge 12. Finally, the control unit 10 can also control the heating cartridge 12 and the heating power thereof and therefore predetermine the temperature of the hot water.

The brewing group 11 comprises in a manner known per se a heating unit 11a, with which the brewing group is preheated and kept warm, and a brewing chamber 11b, in which metered, freshly ground powdered coffee 11c is poured. A brewing group which can be used in the context of the present invention is described, for example, in EP 2561778 A1, to which reference is hereby made in its entirety in order to avoid unnecessary repetition.

The brewing group 11 is configured in such a manner that it can be opened in order to introduce a metered quantity of powdered coffee which is freshly ground in a metered manner in the grinder of the beverage preparation apparatus. Furthermore, the remaining coffee grounds can be discarded into a used coffee container when the brewing group is open after the brewing operation. The brewing group 11 further has a movable piston (not illustrated) which compresses the introduced powdered coffee against a brewing filter which is located in the brewing group 11b. After the piston has been withdrawn, the powdered coffee 11c which is compressed in this manner can be flowed through by the pressurized brewing water.

The pressure which is generated by the pump 13 and at which the brewing water is directed through the brewing chamber 11b is typically approximately from 8 to 12 bar without the invention being limited thereto, however. This pressure of the brewing water decreases in conventional coffee machines over the coffee grounds 11c which are compressed in the brewing chamber 11b. The speed at which the brewing water runs through the powdered coffee 11c is decisively dependent on the degree of grinding of the powdered coffee, the type of coffee, the quantity and the compression degree. In the brewing apparatus described here, however, the pressure decrease is particularly carried out at the counter-pressure valve 19 which is arranged behind the brewing chamber 11b and with which the throughflow speed or throughflow rate of the brewing water through the brewing chamber can be selectively controlled via the control unit 10, in accordance with the actually measured throughflow rate in the throughflow sensor 17. In the exemplary embodiment, the counter-pressure valve 19 is in the form of a needle valve which is driven via a stepping motor.

The operating lever 5 is fixed to the outlet device 3 in an articulated manner and has an electrical consumer 5a which generates a signal which is dependent on a redirection of the operating lever 5. In this case, the consumer can operate in both an analog and a digital manner. For example, a potentiometer at which a voltage which is proportional to the redirection decreases could be used as the consumer. Similarly, a plurality of discrete micro-switches which are connected by the lever in accordance with the redirection of the lever 15 can be used. As already explained, the operating lever 5 acts as a mechanical operating element for inputting a profile for a brewing parameter by a user. The operating lever 5 can be redirected out of a neutral position, for example, the central position thereof, in two directions. The electrical consumer 5a is connected to the control unit which reads the actuation state of the operating lever 5. In accordance with the redirection of the operating lever 5, the control unit 10 changes the relevant brewing parameter.

In the exemplary embodiment, there is provision for the brewing pressure to be able to be increased or decreased via the operating lever 5. If the control unit 10 detects a corresponding redirection of the operating lever 5, it decreases or increases the speed of the water pump 13 in order to increase or decrease the brewing pressure. If the brewing pressure is reduced, the throughflow rate through the brewing group 11 is also thereby reduced. This is detected by the throughflow meter 17 and read by the control unit 10 which subsequently increases the valve opening of the counter-pressure valve 19 in order to increase the throughflow rate again so that a predetermined total throughflow time is achieved. As a result, it is possible for the predetermined total quantity of hot water to flow through the brewing group 11 in the predetermined total throughflow time, regardless of how the pump speed changes by corresponding actuation of the operating lever 5 during the preparation operation.

Via the user interface 9, a user can also select an alternative operating mode, in which via the operating lever 5 the throughflow rate can be directly increased or decreased instead of the brewing pressure. In this case, the control unit 10 controls the counter-pressure valve 19 in accordance with the redirection of the operating lever 5.

Via the graphic user interface 9, a training mode can further be started. In this training mode, the redirection of the operating lever 5 during the preparation operation of a beverage is displayed and the profile input in this manner stored. This profile can then be used to prepare and dispense future beverages. Consequently, coffee variants which are individually made by a barista can be automatically produced and dispensed with the coffee machine 1.

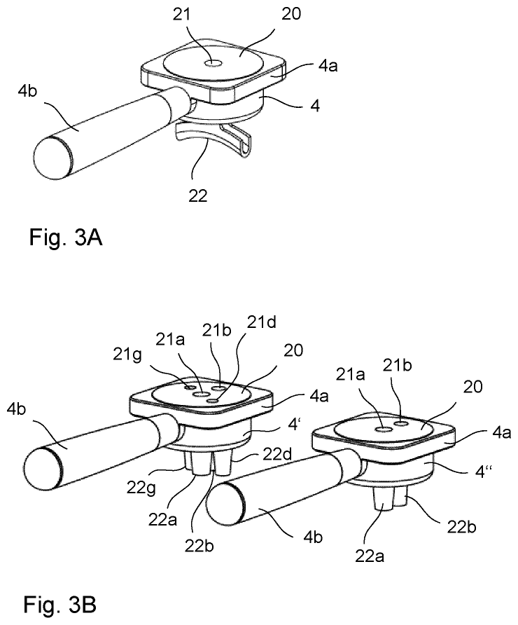

However, the design of the coffee machine 1, the function of which corresponds to a conventional fully automatic coffee machine, is adapted from a professional filter holder machine. To this end, the outlet head 4 is adapted to the form of a filter holder. FIG. 3A shows a first outlet head 4. It has a holder 4a which is formed similarly to a conventional filter holder and is provided with a handle 4b. The handle 4b is optional and may also be omitted or configured in a different form, for instance, as shown in FIG. 1, in the form of a simply narrower gripping edge which projects forward.

At the upper side of the holder 4a, there is formed a circular sealing face 20 in which in the embodiment shown an opening 21 which corresponds to a double outlet 22 at the lower side of the outlet head is located. Two espresso cups can be positioned under the double outlet 22 and filled simultaneously. The outlet head 4 is configured in a changeable manner and is inserted in a receiving member of the outlet device 3 and locked at that location. A sealing connection and fluid connection between the outlet head 4 and outlet device 3 are brought about via the sealing face 20. In the outlet device 3, a coffee line which leads from the brewing group 11 to the outlet device 3 terminates. Furthermore, additional lines for beverage components, such as milk, milk foam or flavoring additives, can be guided to the outlet device 3. Corresponding outlet openings in the receiving member of the outlet device cooperate with the sealing face 20 of the outlet head 4. If the outlet head 4 shown in FIG. 3A is used, these additional outlet openings are closed by the sealing face 20 so that no other beverage components can be dispensed except for espresso coffee.

FIG. 3B shows two other alternately usable outlet heads 4′, 4″. In the left outlet head 4′, for example, four outlet openings 21a, 21b, 21d and 21g which correspond to corresponding outlets in the receiving member of the outlet device 3 are present. Consequently, a total of four different beverage components can be dispensed with this outlet head 4′ and mixed. For example, coffee beverages can be dispensed with milk foam and additional liquid flavor additives.

The outlet head 4″ has two openings 21a, 21b which correspond to outlets 22a, 22b at the lower side of the outlet head 4″. Two beverage components can be dispensed via the outlet device 3′ via these outlet openings 21a, 21b and associated outlets 22a, 22b. The central outlet opening 21a serves to dispense freshly brewed coffee and the outlet device 21b serves to dispense milk foam.

Consequently, depending on the selection of the corresponding outlet head 4, 4′, 4″, different beverages can be dispensed. Depending on which beverage is intended to be prepared and dispensed, therefore, the barista selects the suitable outlet head and connects it to the outlet device 3. Preferably, the outlet heads 4, 4′, 4″ are provided with an RFID tag which can be read by an RFID reader which is arranged on the outlet device 3. The outlet head and the beverage components which can be dispensed thereby can be identified via the RFID tag so that via a corresponding control unit of the beverage preparation apparatus only the beverages or beverage variants which can be dispensed with the relevant outlet head 4, 4′, 4″ are released and displayed for selection on the user interface 9 thereof. Simply by changing an outlet head, consequently, other beverage variants can be provided.

In the context of a preferred embodiment, a heating cartridge with a low thermal mass which allows rapid heating acts as a hot water preparation unit 12. The heating cartridge has a cylindrical internal member and an external cover which surrounds it, wherein between the covering face of the internal member and the inner side of the cover a helically extending flow channel for water to be heated is formed. Such a structural type allows a particularly compact structure in addition to a low thermal mass.

In this structural type, the electrical heating unit is in the form of a heating coil which is arranged inside the cylindrical internal member so as to extend helically around the center axis thereof in axially adjacent portions of the internal member. In particular, the heating coil can be wound around an axially arranged heat-resistant core. The intermediate space between the heating coils and the outer skin of the internal member can be filled with a powdered material, such as, for example, magnesium oxide or another oxide, which is electrically insulating, on the one hand, and thermally conductive, on the other.

As a result of the low thermal mass, it is possible to change the brewing temperature during beverage preparation by adjusting or varying the heating power so that brewing can be carried out not only at a variable throughflow rate and at variable pressure but also at a variable temperature.

1. A beverage preparation apparatus for automatically dispensing hot beverages, comprising:
a hot water preparation unit (12);
a brewing apparatus (11) to which hot water is suppliable from the hot water preparation unit (12);
a water pump (13) that conveys pressurized water in a direction of the brewing apparatus (11);
an outlet device (3) connected to the brewing apparatus (11) via a hot beverage line;
a controller (10) which controls automatic preparation and dispensing of the selected beverage after a beverage selection has been carried out;
the controller (10) is configured to vary a brewing pressure at which the hot water is supplied to the brewing apparatus (11) or a throughflow rate at which the hot water is conveyed, over a preparation operation of a selected beverage in accordance with a predetermined or predeterminable profile; and
a mechanical operating element (5) having an electrical consumer (5a) connected to the controller (10) in order to predetermine the profile.

2. The beverage preparation apparatus as claimed in claim 1, wherein a variation of the brewing pressure is carried out via control of a speed of the water pump (13).

3. The beverage preparation apparatus as claimed in claim 1, further comprising a controllable counter-pressure valve (19) arranged in a throughflow direction downstream of the brewing apparatus (11), and a variation of the brewing pressure or the throughflow rate is carried out via an adjustment of a valve opening of the counter-pressure valve (19).

4. The beverage preparation apparatus as claimed in claim 1, further comprising a measuring device (17) arranged upstream or downstream of the brewing apparatus (11), for determining a volume flow of the brewing water or a quantity of the brewing water which has already been guided through or which has yet to be guided through and an adjustable counter-pressure valve (19) arranged in a throughflow direction downstream of the brewing apparatus (11), the controller (10) is configured to vary the brewing pressure, at which the hot water is supplied to the brewing apparatus (11), in accordance with a pressure profile which is predetermined via the operating element (5) and to control the throughflow rate of the brewing water via the counter-pressure valve (19) in accordance with measurement values of the measuring device (17) during the brewing operation such that during the preparation operation, independently of the pressure profile which is predetermined via the operating element (5), a total quantity of brewing water as predetermined for the selected beverage is guided through within a predetermined total throughflow time.

5. The beverage preparation apparatus as claimed in claim 3, wherein the counter-pressure valve (19) comprises a motor-operated needle valve and the controller (10) further opens or closes the needle valve by controlling a drive motor.

6. The beverage preparation apparatus as claimed in claim 4, wherein the measuring device (17) comprises a throughflow sensor which is arranged in the flow direction upstream of the water pump (13) or between the water pump (13) and the brewing apparatus (11).

7. The beverage preparation apparatus as claimed in claim 4, wherein the controller (10) is configured to establish at least several times from measured volume flow values the quantity of the brewing water which has already been guided through or which still has to be guided through and, according to how much of the brewing water that still has to be guided through the brewing apparatus in order to achieve the predetermined total quantity in the remaining time until reaching the predetermined total throughflow time, to further open or to further close the counter-pressure valve (19) in order to increase or decrease the volume flow.

8. The beverage preparation apparatus as claimed in claim 1, wherein the mechanical operating element (5) comprises an operating lever which is redirectable from a neutral position in a first direction in order to increase the brewing pressure or the throughflow rate and in a second direction in order to reduce the brewing pressure or the throughflow rate.

9. The beverage preparation apparatus as claimed in claim 1, wherein an optical, acoustic or haptic confirmation signal is output when the operating element (5) is actuated.

10. The beverage preparation apparatus as claimed in claim 1, wherein the controller (10) has a training mode, in which a profile is input by actuating the operating element (5) and the input profile is stored for subsequent automatic product purchases.

11. The beverage preparation apparatus as claimed in claim 1, further comprising at least one outlet head (4, 4′, 4″) which is fixable to the outlet device (3) for dispensing one or more beverage components which is/are guided to the outlet device (3) via separate food product lines, and the outlet device (3) has a mechanical interface for sealingly connecting the outlet head (4, 4′, 4″).

12. The beverage preparation apparatus as claimed in claim 11, wherein the at least one outlet head comprises a plurality of outlet heads (4, 4′, 4″) which are connectable alternately to the outlet device (3) for different beverages or beverage groups.

13. The beverage preparation apparatus as claimed in claim 11, wherein the outlet head (4, 4′, 4″) comprises a filter holder having an upper side formed by a sealing face (20) which is provided with connection openings (21, 21a, 21b, 21d, 21g) and is otherwise closed.

14. The beverage preparation apparatus as claimed in claim 1, further comprising a grinding mechanism for grinding coffee beans, which cooperates with the brewing apparatus (11) in order to automatically fill the brewing apparatus (11) with a metered quantity of freshly ground powdered coffee.
